(19) United States
(12) Patent Application Publication
(10) Pub. No.: US 2025/0166889 A1
(43) Pub. Date: May 22, 2025

(54) METHOD FOR CO-SINTERING TRANSFORMER

(71) Applicant: TAI-TECH ADVANCED ELECTRONICS CO., LTD., Taoyuan City (TW)

(72) Inventors: Ming-Yen Hsieh, Taoyuan City (TW); Pao-Lin Shen, Taoyuan City (TW); Hsiang-Chung Yang, Taoyuan City (TW); Jian-Hong Lai, Taoyuan City (TW); Kuan-Yi Lu, Taoyuan City (TW)

(21) Appl. No.: 18/511,925

(22) Filed: Nov. 16, 2023

(51) Int. Cl. H01F 41/02; H01F 1/22

(52) U.S. Cl. CPC H01F 41/02; H01F 1/22

(57) ABSTRACT

The method for co-sintering transformer includes the following steps: a preparation step providing a copper conductor strip and an iron core; a coating step applying a layer of nickel coating, or a layer of precious metal coating, or both on the copper conductor strip from the preparation step; an assembly step putting the copper conductor strip from the coating step and the iron core from the preparation step together to form a transformer; a pressing step pressing the assembled copper conductor strip and the iron core from the assembly step, together with iron power, in a mold into an integrally formed transformer; and a sintering step sintering the pressed transformer from the pressing step in an atmospheric environment. The present method is able to conduct sintering directly under the atmospheric environment without reducing oxygen content. Iron powder also exhibits improved characteristics after sintering in the atmospheric environment.

### BACKGROUND OF THE INVENTION

### (a) Technical Field of the Invention

The present invention generally relates to transformers, and more particularly to a method for co-sintering transformer.

### (b) Description of the Prior Art

People's Republic of China Patent No. CN105940466B, titled “A metal composite wire, power transformer, and preparation method thereof,” as shown in its FIGS. 1 and 2, coats a glass resin mixture onto the surface of a metal core to form a metal composite wire. The wire and magnetic powder are placed together into a mold and integrally pressed into a transformer. The transformer is then sintered in an environment with an oxygen content below 15% under a temperature 600˜900° C.

This teaching is able to produce power transformers. However, the teaching requires that the sintering has to be conducted in an environment with a limited oxygen content, instead of in the atmospheric environment whose oxygen content is 21%. This constrain means that a step of reducing oxygen content has to be additionally performed.

### SUMMARY OF THE INVENTION

Therefore, the present invention teaches a method for co-sintering transformer, which includes the following steps:
preparation step: providing a copper conductor strip and an iron core;
coating step: applying a layer of nickel coating or a layer of precious metal coating, or first a layer of nickel coating and then a layer of precious metal coating on the copper conductor strip from the preparation step;
assembly step: putting the copper conductor strip from the coating step and the iron core from the preparation step together to form a transformer;
pressing step: placing the assembled copper conductor strip and the iron core from the assembly step into a mold, filling iron power into the mold, and producing an integrally formed transformer by pressing; and
sintering step: sintering the pressed transformer from the pressing step in an atmospheric environment with an oxygen content of 21% at a temperature 600˜900° C. for a duration 0.5˜3 hours.

The present method, as described above, is able to conduct sintering directly under the atmospheric environment without an additional step to control oxygen content. In addition, iron powder exhibits improved characteristics after sintering in the atmospheric environment, and compared to prior art, the oxidation resistance and conductivity with a second metal layer of precious metal coating are superior.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing a method of co-sintering transformer according to an embodiment of the present invention.

FIG. 2 shows a copper conductor strip and an iron core used by the method of FIG. 1.

FIG. 3 is a schematic diagram showing the copper conductor strip and the iron core of FIG. 2.

FIG. 4 is a schematic sectional diagram showing the copper conductor strip of FIG. 2 with a layer of nickel coating.

FIG. 5 is a schematic sectional diagram showing the copper conductor strip of FIG. 2 with a layer of precious metal coating.

FIG. 6 is a schematic sectional diagram showing the copper conductor strip of FIG. 2 with a layer of nickel coating and then with a layer of precious metal coating.

FIG. 7 shows the copper conductor strip and the iron core of FIG. 2 assembled together.

FIG. 8 shows an integrally formed transformer made according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

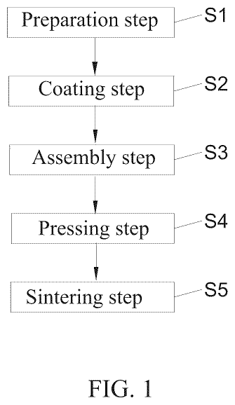

As shown in FIG. 1, a method for co-sintering transformer according to an embodiment of the present invention includes the following steps.

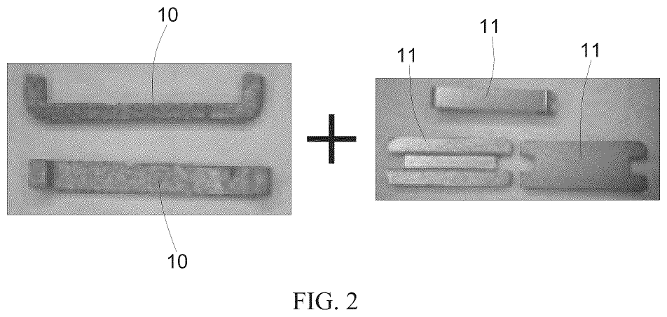

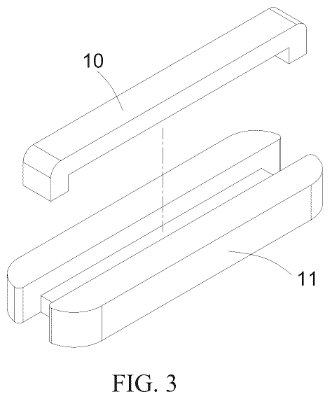

Preparation step S1: providing a copper conductor strip 10 and an iron core 11, as shown in FIGS. 2 and 3.

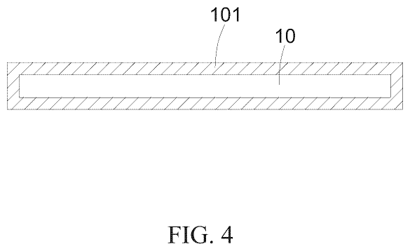

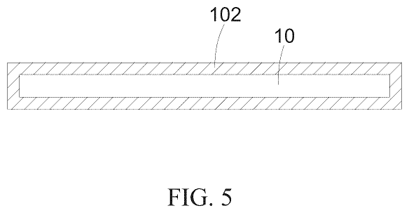

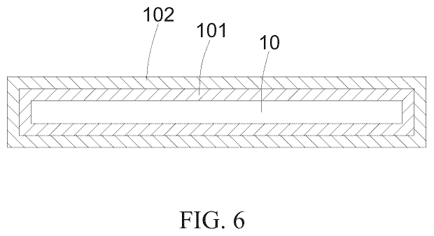

Coating step S2: applying a layer of nickel coating 101 or a layer of precious metal coating 102, or first a layer of nickel coating 101 and then a layer of precious metal coating 102 on the copper conductor strip 10 from the preparation step S1, as shown in FIGS. 4, 5, and 6.

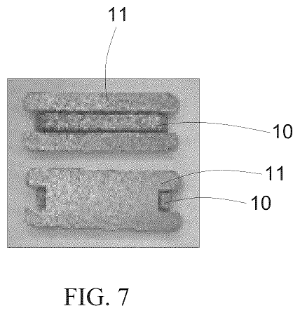

Assembly step S3: putting the copper conductor strip 10 from the coating step S2 and the iron core 11 from the preparation step S1 together to form a transformer 1, as shown in FIG. 7.

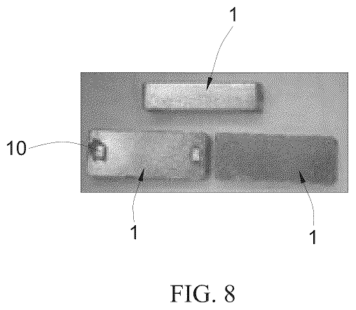

Pressing step S4: placing the assembled copper conductor strip 10 and the iron core 11 from the assembly step S3 into a mold, filling iron power into the mold, and producing an integrally formed transformer 1 by pressing, as shown in FIG. 8.

Sintering step S5: sintering the pressed transformer 1 from the pressing step S4 in an atmospheric environment.

Specifically, the atmospheric environment is an environment with an oxygen content of 21%.

Specifically, the temperature for the sintering step S5 is 600˜900° C., with a duration 0.5˜3 hours.

Specifically, the thickness of the nickel coating 101 is 0.1˜20 μm.

Specifically, the precious metal coating 102 can be made of gold, with a thickness of 0.1˜1 μm.

Specifically, the precious metal coating 102 can be made of silver, with a thickness of 0.1˜10 μm.

Specifically, the precious metal coating 102 can be made of platinum, with a thickness of 0.1˜1 μm.

The following provide direct-current (DC) impedance values measured from transformers produced under various sintering conditions.

Table 1 lists DC impedance values for transformers whose copper conductor strip 10 has the layer of nickel coating 101 sintered under the atmospheric environment at 600° C. for 1 hour (hr.):

TABLE 1

| # | Coating | Sintering condition | DC impedance (Ω) |
|---|---|---|---|
| 1 | None | No sintering | 0.450 |
| 2 | None | Atmospheric | 0.476 |
| 3 | nickel coating 1 μm | environment 600° C. | 0.450 |
| 4 | nickel coating 20 μm | 1 hr | 0.440 |

Table 2 lists DC impedance values for transformers whose copper conductor strip 10 has the layer of nickel coating 101 sintered under the atmospheric environment at 720° C. for 1 hr.

TABLE 2

| # | Coating | Sintering condition | DC impedance (Ω) |
|---|---|---|---|
| 1 | None | No sintering | 0.450 |
| 2 | None | Atmospheric | 0.642 |
| 3 | nickel coating 1 μm | environment 720° C. | 0.469 |
| 4 | nickel coating 20 μm | 1 hr | 0.426 |

Table 3 lists DC impedance values for transformers whose copper conductor strip 10 has the layer of precious metal (silver) coating 102 sintered under the atmospheric environment at 600° C. for 1 hr.

TABLE 3

| # | Coating | Sintering condition | DC impedance (Ω) |
|---|---|---|---|
| 1 | None | No sintering | 0.450 |
| 2 | None | Atmospheric | 0.476 |
| 3 | silver coating 3 μm | environment 600° C. | 0.418 |
| 4 | silver coating 5 μm | 1 hr | 0.416 |
| 5 | silver coating 10 μm | | 0.413 |

Table 4 lists DC impedance values for transformers whose copper conductor strip 10 has the layer of precious metal (silver) coating 102 sintered under the atmospheric environment at 720° C. for 1 hr.

TABLE 4

| # | Coating | Sintering condition | DC impedance (Ω) |
|---|---|---|---|
| 1 | None | No sintering | 0.450 |
| 2 | None | Atmospheric | 0.642 |
| 3 | silver coating 3 μm | environment 720° C. | 0.443 |
| 4 | silver coating 5 μm | 1 hr | 0.442 |
| 5 | silver coating 10 μm | | 0.445 |

Table 5 lists DC impedance values for transformers whose copper conductor strip 10 has the layer of nickel coating 101 and the layer of precious metal (gold or silver) coating 102 sequentially applied and sintered under the atmospheric environment at 600° C. for 1 hr.

TABLE 5

| # | Coating | Sintering condition | DC impedance (Ω) |
|---|---|---|---|
| 1 | None | No sintering | 0.450 |
| 2 | None | Atmospheric | 0.476 |
| 3 | nickel coating 1 μm + | environment 600° C. | 0.442 |
| | gold coating 0.5 μm | 1 hr | |
| 4 | nickel coating 5 μm + | | 0.454 |
| | gold coating 0.5 μm | | |
| 5 | nickel coating 20 μm + | | 0.445 |
| | gold coating 0.5 μm | | |
| 6 | nickel coating 1 μm + | | 0.422 |
| | silver coating 3 μm | | |
| 7 | nickel coating 1 μm + | | 0.416 |
| | silver coating 5 μm | | |
| 8 | nickel coating 1 μm + | | 0.403 |
| | silver coating 10 μm | | |

Table 6 lists DC impedance values for transformers whose copper conductor strip 10 has the layer of nickel coating 101 and the layer of precious metal (gold or silver) coating 102 sequentially applied and sintered under the atmospheric environment at 720° C. for 1 hr.

TABLE 6

| # | Coating | Sintering condition | DC impedance (Ω) |
|---|---|---|---|
| 1 | None | No sintering | 0.450 |
| 2 | None | Atmospheric | 0.642 |
| 3 | nickel coating 1 μm + | environment 720° C. | 0.441 |
| | gold coating 0.5 μm | 1 hr | |
| 4 | nickel coating 5 μm + | | 0.460 |
| | gold coating 0.5 μm | | |
| 5 | nickel coating 20 μm + | | 0.419 |
| | gold coating 0.5 μm | | |
| 6 | nickel coating 1 μm + | | 0.441 |
| | silver coating 3 μm | | |
| 7 | nickel coating 1 μm + | | 0.436 |
| | silver coating 5 μm | | |
| 8 | nickel coating 1 μm + | | 0.415 |
| | silver coating 10 μm | | |

As it is preferable for the DC impedance of transformer 1 to be as low as possible, it can be observed from the data above that transformers 1 having a nickel coating 101, or a precious metal coating 102, or a nickel coating 101 first and then followed by a precious metal coating 102 applied to the copper conductor strip 10 by the coating step S2, all exhibit lower DC impedance compared to transformers sintered directly without any coating on the copper conductor strip 10.

By applying a nickel coating 101 to the copper conductor strip 10, the nickel coating 101 prevents the oxidation of copper conductor strip 10 when the transformer 1 undergoes sintering in an atmospheric environment. Additionally, when copper conductor strip 10 is coated with a layer of precious metal coating 102 or when nickel coating 101 is applied first and then followed by a layer of precious metal coating 102, the copper conductor strip 10 is protected from oxidation during sintering in an atmospheric environment. Therefore, the present invention does not require the control of oxygen content during the sintering step S5. This allows for sintering directly in an atmospheric environment while achieving good DC impedance characteristics. Furthermore, the iron powder sintered in an atmospheric environment exhibits better insulation properties, and compared to prior art, the precious metal coating 102 demonstrates superior oxidation resistance and conductivity.”

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A method for co-sintering transformer, comprising:
preparation step: providing a copper conductor strip and an iron core;
coating step: applying a layer of nickel coating or a layer of precious metal coating, or first a layer of nickel coating and then a layer of precious metal coating on the copper conductor strip from the preparation step;
assembly step: putting the copper conductor strip from the coating step and the iron core from the preparation step together into a transformer;
pressing step: placing the assembled copper conductor strip and the iron core from the assembly step into a mold, filling iron power into the mold, and producing an integrally formed transformer by pressing; and
sintering step: sintering the pressed transformer from the pressing step in an atmospheric environment.

2. The method for co-sintering transformer according to claim 1, wherein the atmospheric environment for the sintering step is an environment with an oxygen content of 21%.

3. The method for co-sintering transformer according to claim 1, wherein the sintering step is conducted at a temperature 600˜900° C.

4. The method for co-sintering transformer according to claim 1, wherein the sintering step is conducted for a duration 0.5˜3 hours.

5. The method for co-sintering transformer according to claim 1, wherein the thickness of the nickel coating is 0.1˜20 μm.

6. The method for co-sintering transformer according to claim 1, wherein the precious metal coating is made of gold with a thickness of 0.1˜1 μm.

7. The method for co-sintering transformer according to claim 1, wherein the precious metal coating is made of silver with a thickness of 0.1˜10 μm.

8. The method for co-sintering transformer according to claim 1, wherein the precious metal coating is made of platinum with a thickness of 0.1˜1 μm.
